(19) United States
(12) Patent Application Publication
(10) Pub. No.: US 2015/0323121 A1
(43) Pub. Date: Nov. 12, 2015

(54) Load Carrying Apparatus

(71) Applicant: JIUN-TYNG DAI, New Taipei City (TW)

(72) Inventor: JIUN-TYNG DAI, New Taipei City (TW)

(21) Appl. No.: 14/271,438

(22) Filed: May 6, 2014

(51) Int. Cl. F16M 11/04; F16F 1/04

(52) U.S. Cl. CPC F16M 11/04; F16F 1/04

(57) ABSTRACT

A load carrying apparatus includes a support board, plural elastic rings, at least two first connecting portions and at least one second connecting portion. The elastic rings are disposed on an outer side of the support board, and the total number of rings is n+1, and n is an integer, and the elastic rings are the first to (n+1)^{th} elastic rings respectively. The first connecting portions are disposed between the support board and the first elastic ring and between the n^{th} elastic ring and the (n+1)^{th} elastic ring and n is an even number. The second connecting portions are disposed between the n^{th} elastic ring and the (n+1)^{th} elastic ring, and n is an odd number. An accommodating space for storing objects is formed when the elastic rings are deformed by an external force.

### BACKGROUND OF THE INVENTION

1. Field of the Invention

The present invention relates to an apparatus for storing objects, and more particularly to a load carrying apparatus that produces a corresponding accommodating space by the weight of an object to achieve the effect of storing the object and maintaining a board-shaped structure when not carrying the object.

2. Description of the Related Art

Various different apparatuses or devices are provided for carrying objects. Regardless of the shape and size of a desired carrying object, there is always a corresponding device for carrying the object. However, these products require at least an accommodating space for containing and storing the object, so that it is necessary to take the accommodating space into consideration for the design, structure and shape of the products in the design and manufacture processes. Therefore, the shape of the product and the position of the accommodating space can no longer be changed after the product is manufactured, and a special mechanical design is required to improve the variability of the appearance of the product and the convenience of the storage when it is necessary to store the product or expand the range of application.

Most common carrying devices including various types of cabinets, boxes and racks have fixed volume and shape. For example, a multi-layer or partitioned rack provides a plurality of areas or spaces for putting objects. If these areas or spaces are not all used, the unused areas or spaces cannot be used for storage, and thus wasting spaces. In addition, the shape and assembly of the manufactured product are fixed, so that the product cannot be moved or changed flexibly, and the mobility and convenience are reduced. At present, modular cabinets that can be installed and removed easily are available in the market, and these cabinets can be added, removed, or replaced easily, so that the cabinets can be changed, stacked or moved easily. However, these cabinets still cannot overcome the problems of wasting unused accommodating spaces and having fixed the accommodating spaces after the space is divided or partitioned in the design, and these spaces cannot be changed according to the size and volume of the objects.

Therefore, the inventor of the present invention designed and developed a load carrying apparatus in accordance with the present invention to overcome the aforementioned drawbacks and problems of the conventional load carrying apparatus.

### SUMMARY OF THE INVENTION

In view of the problems of the prior art, it is a primary objective of the present invention to overcome the problems of the prior art by providing a load carrying apparatus for storing various types of objects, and the load carrying apparatus is in form of a board when not in use, and thus the load carrying apparatus provides a convenient storage and saves spaces. When the load carrying apparatus carries an object, the weight of the object is exerted onto the load carrying apparatus to produce an accommodating space which is most suitable for containing and storing the object, so as to prevent wasting unnecessary space, and plural load carrying apparatuses may be connected according to a user's requirement to achieve the effect of storing a large quantity of objects, and the load carrying apparatus can be used a chair based on the design of style, shape and size.

To achieve the aforementioned objective, the present invention provides a load carrying apparatus, comprising: a support board; a plurality of elastic rings, disposed on an outer side of the support board, and the total number of the elastic rings being n+1, and n being an integer, and the elastic rings being defined as the first to (n+1)^{th} elastic rings respectively; at least two first connecting portions, disposed between the support board and the first elastic ring, and between the n^{th} elastic ring and the (n+1)^{th} elastic ring, and n being an even number; and at least one second connecting portion, disposed between the n^{th} elastic ring and the (n+1)^{th} elastic ring, and n being an odd number, wherein an accommodating space is formed after the elastic rings are deformed by an external force, and the support board acts as a load carrying point.

Wherein, the (n+1)^{th} elastic ring has a top area and bottom area greater than those of each of the remaining elastic rings, and the (n+1)^{th} elastic ring has at least one assembling portion for assembling a plurality of load carrying apparatuses.

In addition, the support board and the elastic rings are in a circular, rectangular or polygonal shape, and the shape of the load carrying apparatus may be changed according to the using conditions or user requirements.

In an implementation mode of a preferred embodiment, the first connecting portions and the second connecting portions come with a plural quantity, and two first connecting portions are disposed between the support board and the first elastic ring and between the n^{th} elastic ring and the (n+1)^{th} elastic ring, and the two first connecting portions disposed at the positions of the same ring are opposite to each other; and two second connecting portions are disposed between the n^{th} elastic ring and the (n+1)^{th} elastic ring, and the two second connecting portions disposed at the positions of the same ring are opposite to each other, so that the first connecting portions and the second connecting portions are arranged as shown in FIG. 1.

In another implementation mode, the first connecting portions and the second connecting portions come with a plural quantity, and at least three first connecting portions are disposed between the support board and the first elastic ring and between the n^{th} elastic ring and the (n+1)^{th} elastic ring; and at least three second connecting portions are disposed between the n^{th} elastic ring and the (n+1)^{th} elastic ring, so that the first connecting portions and the second connecting portions are arranged as shown in FIG. 3.

In another preferred embodiment, the first connecting portions and the second connecting portions come with a plural quantity, and four first connecting portions are disposed between the support board and the first elastic ring and between the n^{th} elastic ring and the (n+1)^{th} elastic rings; and two second connecting portions are disposed between the n^{th} elastic ring and the (n+1)^{th} elastic ring, and the two second connecting portions disposed at the positions of the same ring are opposite to each other, so that the first connecting portions and the second connecting portions are arranged as shown in FIG. 4.

In the aforementioned preferred embodiment, the first connecting portions disposed at the positions of different rings and the second connecting portions disposed at the positions of different rings are aligned precisely with each other.

In another preferred embodiment, the first connecting portions and the second connecting portions come with a plural quantity; four first connecting portions are disposed at the (n<15)^{th} elastic ring, between the support board and the first elastic ring, and between the n^{th} elastic ring and the (n+1)^{th} elastic ring; six first connecting portions are disposed at the (n>15)^{th} elastic ring and between the n^{th} elastic ring and the (n+1)^{th} elastic ring; two second connecting portions are disposed at the (n<15)^{th} elastic ring, and between the n^{th} elastic ring and the (n+1)^{th} elastic ring; and four second connecting portions are disposed at the (n>15)^{th} elastic ring, and between the n^{th} elastic ring and the (n+1)^{th} elastic ring, so that the first connecting portions and the second connecting portions are arranged as shown in FIG. 6.

### BRIEF DESCRIPTION OF THE DRAWINGS

FIG. 1 is a schematic planar view of a first preferred embodiment of the present invention;

FIG. 2A is a first schematic view showing an operation of the first preferred embodiment of the present invention;

FIG. 2B is a second schematic view showing an operation of the first preferred embodiment of the present invention;

FIG. 3 is a schematic planar view of another implementation mode of the present invention;

FIG. 4 is a schematic planar view of a further implementation mode of the present invention;

FIG. 5 is a schematic view of an application of the first preferred embodiment of the present invention;

FIG. 6 is a schematic planar view of a second preferred embodiment of the present invention;

FIG. 7A is a first schematic view showing an operation of the second preferred embodiment of the present invention; and

FIG. 7B is a second schematic view showing an operation of the second preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

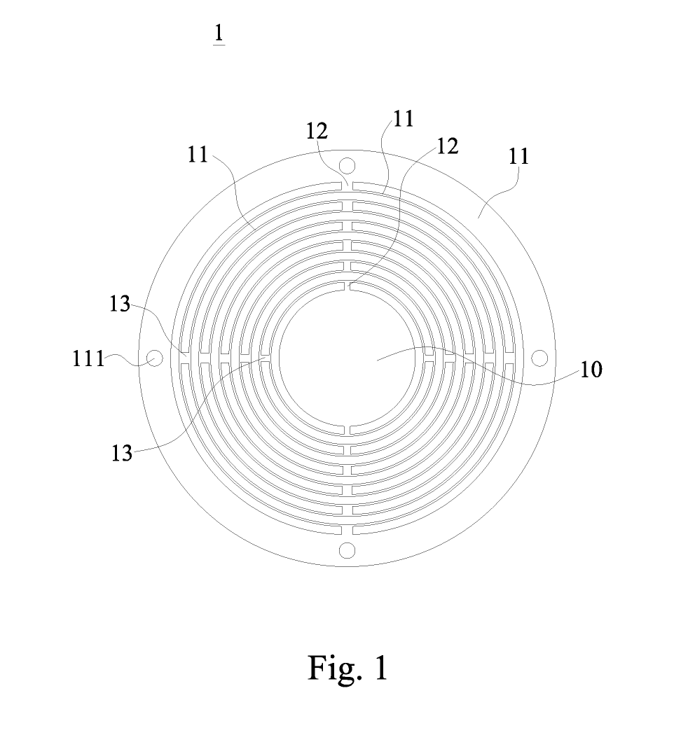

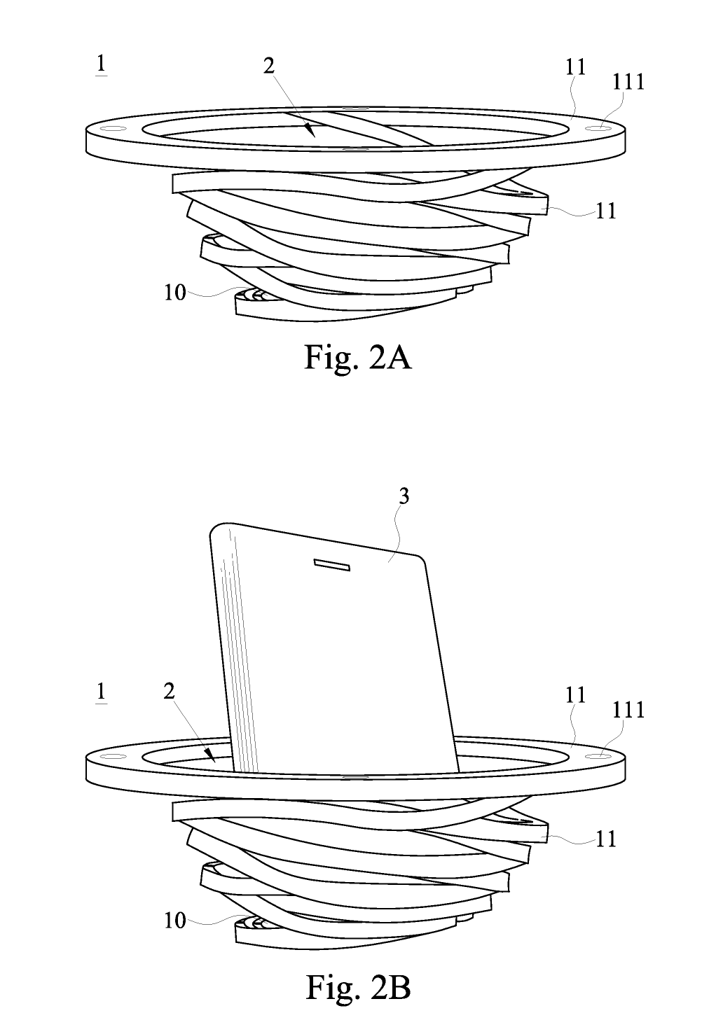

With reference to FIGS. 1, 2A and 2B for a schematic planar view of a load carrying apparatus 1 in accordance with a first preferred embodiment of the present invention and schematic views showing the operation of the load carrying apparatus respectively, the load carrying apparatus has an accommodating space 2 formed by the effect of gravitation and provided for carrying objects or serves as a chair. The load carrying apparatus 1 comprises a support board 10, a plurality of elastic rings 11, at least two first connecting portions 12 and at least one second connecting portion 13.

The support board 10 is used as a load carrying point of the load carrying apparatus 1. When the load carrying apparatus 1 is used for carrying an object, forces are exerted onto the support board 10 while the support board 10 is used for carrying the object, so that the object has an area for applying a force.

the elastic rings 11 are disposed on an outer side of the support board 10, and the total number of elastic rings 11 is equal to n+1, wherein n is an integer, and the elastic rings 11 are the first to the (n+1)^{th} elastic rings 11 respectively. In this preferred embodiment, n is equal to 10, so that the total number of the elastic rings 11 is equal to 11, but the invention is not limited to such arrangement only. Wherein, the (n+1)^{th} elastic ring 11 has a top area and a bottom area greater than those of each of the remaining elastic rings 11. Preferably, at least one assembling portion 111 is disposed at the (n+1)^{th} elastic ring 11. In this preferred embodiment, there are four assembling portions 111 which are through holes penetrating through the (n+1)^{th} elastic rings 11 respectively, and the assembling portions 111 are provided for combining a plurality of load carrying apparatuses 1 to form a large load carrying apparatus.

At least two first connecting portions 12 are disposed between the support board 10 and the first elastic ring 11, and between the n^{th} elastic ring 11 and the (n+1)^{th} elastic ring 11, and n is an even number. In this preferred embodiment, the first connecting portions 12 come with a plural quantity, and at least one first connecting portion 12 is disposed between the support board 10 and the first elastic ring 11, and the remaining first connecting portions 12 are disposed between the n^{th} elastic ring 11 (where n=2, 4, 6, 8, 10) and the (n+1)^{th} elastic ring (where, n+1=3, 5, 7, 9, 11) for enhancing the rigidity of the load carrying apparatus 1, and the force exerting condition of the load carrying apparatus 1 can be adjusted according to the configuration of the first connecting portions 12.

At least one second connecting portion 13 is disposed between the n^{th} elastic ring 11 and the (n+1)^{th} elastic ring 11, and n is an odd number. In this preferred embodiment, there are plural second connecting portions 13, and the second connecting portions 13 are disposed between the n^{th} elastic ring 11 (where n=1, 3, 5, 7, 9, 11) and the (n+1)^{th} elastic ring 11 (where n+1=2, 4, 6, 8, 10), which is the same as the first connecting portions 12, so that the second connecting portions 13 can improve the rigidity of the load carrying apparatus 1, and the configuration of the second connecting portions 13 can be adjusted to change the force exerting condition of the load carrying apparatus 1.

It is noteworthy that the whole load carrying apparatus 1 is similar to a board, and the first connecting portions 12 disposed at positions of different rings and the second connecting portions 13 disposed at positions of different rings are aligned precisely with each other as shown in FIG. 1, so that the first connecting portions 12 and the second connecting portions 13 are aligned substantially in a straight line on the load carrying apparatus 1. In this preferred embodiment, two first connecting portions 12 are disposed between the support board 10 and the first elastic ring 11 and between the n^{th} elastic ring 11 and the (n+1)^{th} elastic ring 11, and the two first connecting portions 12 disposed at positions of the same ring are opposite to each other. Two second connecting portions 13 are disposed between the n^{th} elastic ring 11 and the (n+1)^{th} elastic ring 11, and the two second connecting portions 13 disposed at positions of the same ring are opposite to each other, so that the first connecting portions 12 and the second connecting portions 13 are arranged into a substantially cross shape.

In FIG. 2A, the support board 10 serves as a force applying point for applying a gravitational force to deform the elastic rings 11 of the load carrying apparatus 1. With the first connecting portions 12 and the second connecting portions 13, a larger elastic deformation is formed at the area of the load carrying apparatus 1 without installing the first connecting portions 12 and the second connecting portions 13, so that the load carrying apparatus 1 forms the accommodating space 2 to achieve the effect of carrying an object. In FIG. 2B, the load carrying apparatus is provided for containing and storing a mobile phone 3. When the mobile phone 3 is placed on a side of the load carrying apparatus 1, the support board 10 acts as the main contact area of carrying the weight, so that the load carrying apparatus 1 is deformed by the weight of the object to form the accommodating space 2 for storing the mobile phone 3. After the mobile phone 3 is removed, the elastic restoring force of the elastic rings 11 returns to their original status (without carrying the object), so that the load carrying apparatus 1 can be stored easily. However, the present invention is not limited to the application for storing the mobile phone 3, but the load carrying apparatus may be applied for any desired carrying object, and the size of the load carrying apparatus 1 may be adjusted to fit the desired carrying object.

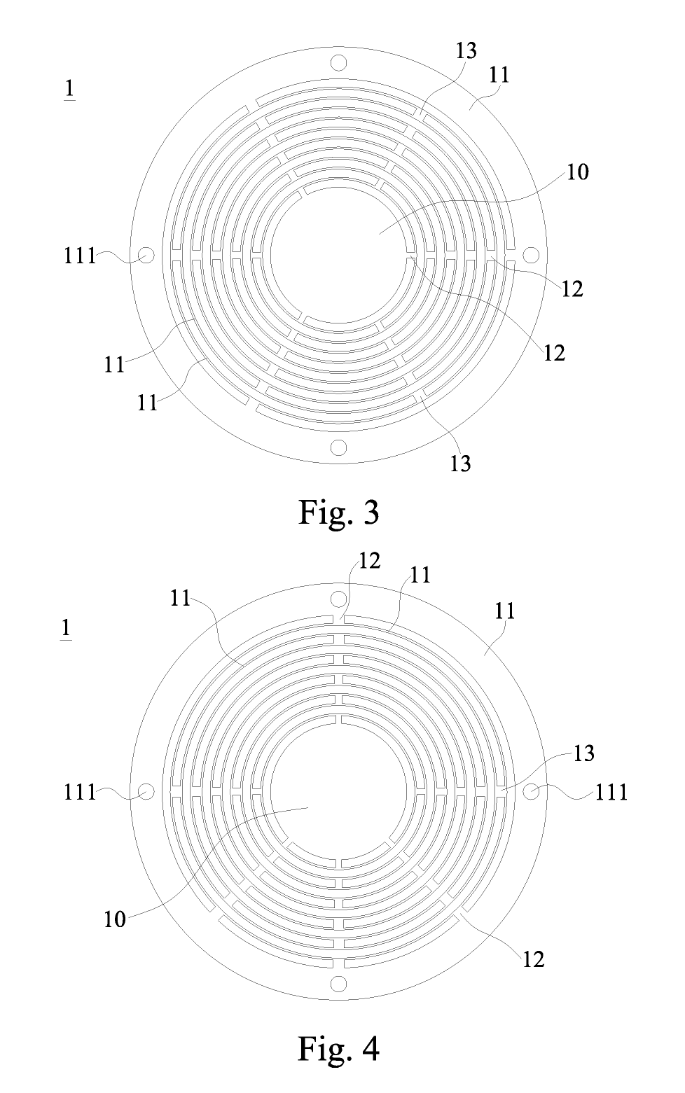

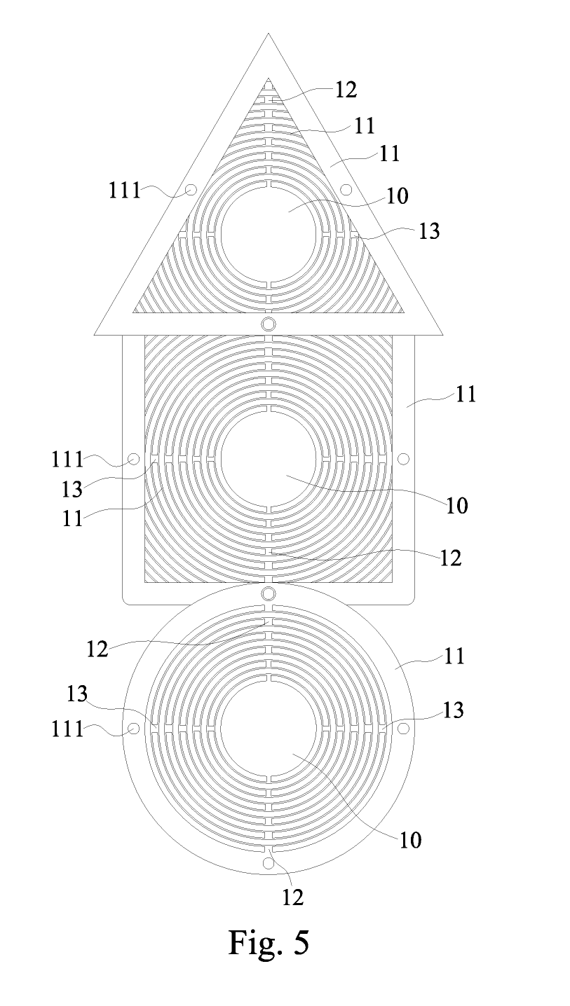

With reference to FIGS. 3 and 4 for other implementation modes of this preferred embodiment respectively, FIG. 3 shows that at least three first connecting portions 12 are disposed between the support board 10 and the first elastic ring 11 and between the n^{th} elastic ring elastic ring 11 and the (n+1)^{th} elastic ring 11; and at least three second connecting portions 12 are disposed between the n^{th} elastic ring 11 and the (n+1)^{th} elastic ring 11. In this implementation mode, the first connecting portions 12 and the second connecting portions 13 disposed at positions of the same ring are separated apart with each other, so that the first connecting portions 12 and the second connecting portions 13 are arranged in a radial form on the load carrying apparatus 1. However, the quantity of the first connecting portions 12 disposed between the support board 10 and the first elastic ring 11 and between the n^{th} elastic ring 11 and the (n+1)^{th} elastic ring 11 and the quantity of the second connecting portions 13 disposed between the n^{th} elastic ring elastic ring 11 and the (n+1)^{th} elastic ring 11 may be 4, 5, 6 or more. In this implementation mode, only three are used.

In FIG. 4, four first connecting portions 12 are disposed between the support board 10 and the first elastic ring 11 and between the n^{th} elastic ring and the (n+1)^{th} elastic ring 11, and two second connecting portions 13 are disposed between the n^{th} elastic ring 11 and the (n+1)^{th} elastic ring 11, and the two second connecting portions 13 disposed at the positions of the same ring are opposite to each other, so that the first connecting portions 12 and the second connecting portions 13 are arranged in the shape as shown in FIG. 4 on the load carrying apparatus 1, and the whole load carrying apparatus 1 has different deformations in different areas. Therefore, the size and shape of the accommodating space of the load carrying apparatus 1 may be changed according to a user's requirement, so as to improve the variability of the load carrying apparatus 1.

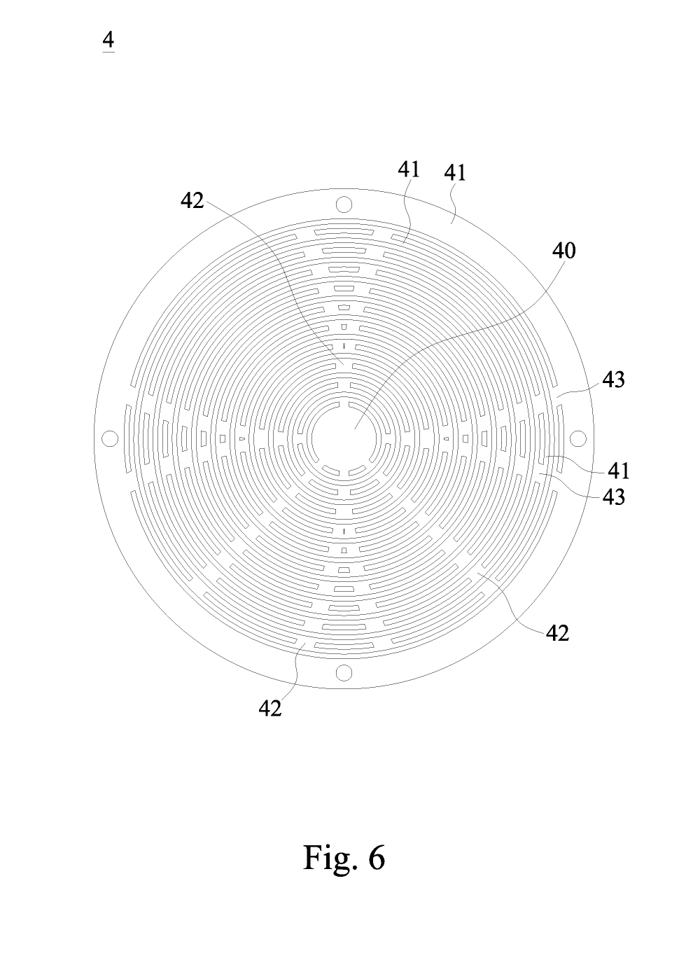

In FIG. 5, the support board 10 and the elastic rings 11 are in a circular, rectangular or polygonal shape, and FIG. 5 shows other shapes of the load carrying apparatus 1, wherein the (n+1)^{th} elastic rings 11 of the load carrying apparatus 1 are in triangular, circular, and rectangular shapes, and the assembling portions 111 are provided for the connection. Of course, the shape of the load carrying apparatus 1 of the present invention is not limited to the aforementioned shapes only.

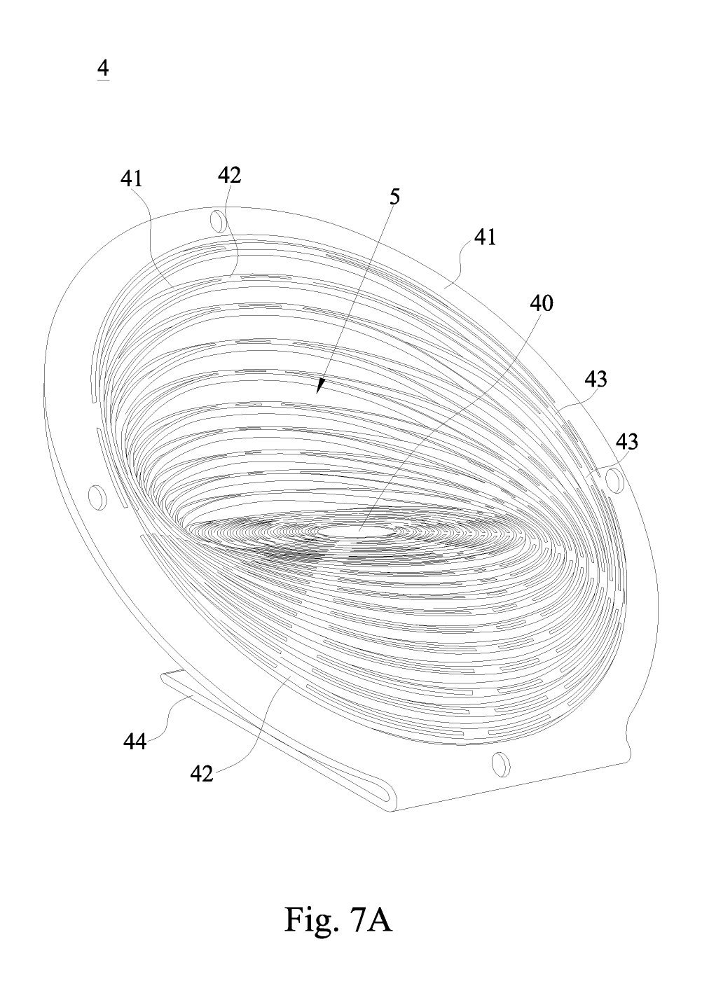

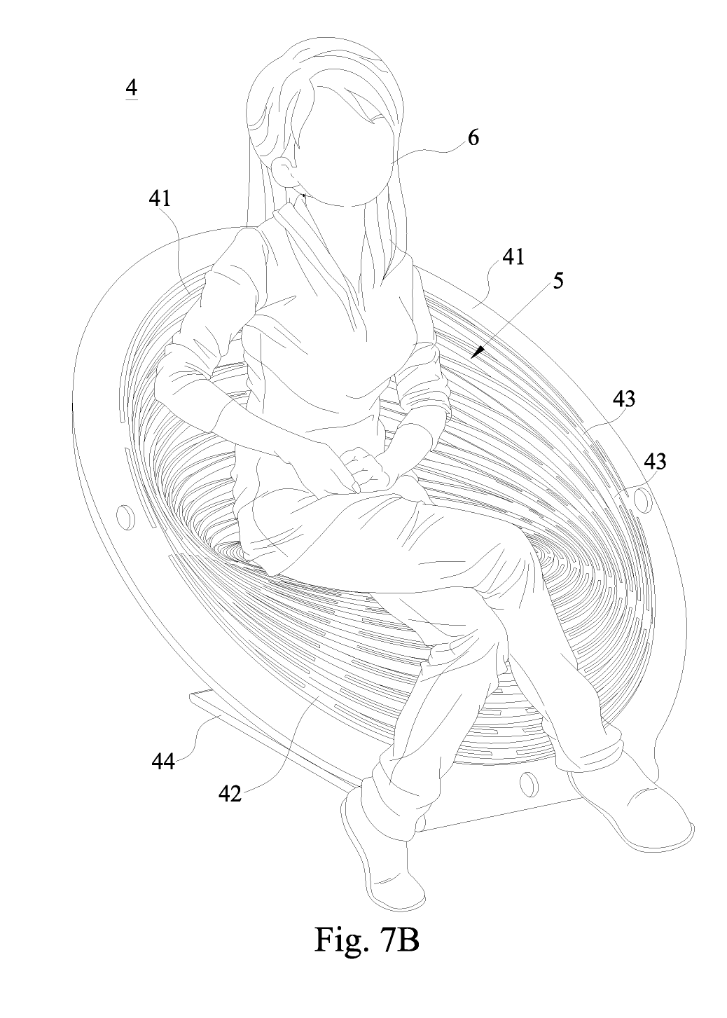

With reference to FIGS. 6, 7A and 7B for a schematic planar view and schematic views showing the operation of the second preferred embodiment of the present invention, only the differences between the first embodiment and this embodiment are described here. In this preferred embodiment, n>30. In other words, the total number of elastic rings 41 of the load carrying apparatus 4 is greater than 31, and four first connecting portions 42 are disposed at the (n<15)^{th} elastic rings 41, between the support board 40 and the first elastic ring 41, and between and the n^{th} elastic ring 41 and the (n+1)^{th} elastic ring 41, and six first connecting portions 42 are disposed at the (n>15)^{th} elastic ring 41, between the n^{th} elastic ring 41 and the (n+1)^{th} elastic ring 4, and two second connecting portions 43 are disposed at the (n<15)^{th} elastic rings 41 and between the n^{th} elastic ring 41 and the (n+1)^{th} elastic ring 41, and four second connecting portions 43 are disposed at the (n>15)^{th} elastic ring 41 and between the n^{th} elastic ring 41 and the (n+1)^{th} elastic ring 41, so that the first connecting portions 42 and the second connecting portions 43 are arranged in a shape as shown in FIG. 6 on the load carrying apparatus 4. Wherein, the first connecting portions 42 and the second connecting portions 43 disposed at the positions of different rings of each of the (n<15)^{th} elastic rings 41 are aligned precisely with each other, so that the first connecting portions 42 and the second connecting portions 43 are arranged substantially in a straight line, and the first connecting portions 42 disposed at the positions of the same ring of each of the (n>15)^{th} elastic rings 41 has a greater gap between each other as the number of rings increases, and the second connecting portions 43 disposed at the positions of the same ring are arranged adjacent to each other, and the gap between the second connecting portions 43 increases with the number of rings. Therefore, the first connecting portions 42 and the second connecting portions 43 are arranged substantially in a V-shape on the load carrying apparatus 4 with a slight curve.

In this preferred embodiment, the first connecting portions 42 and the second connecting portions 43 are arranged asymmetrically on the load carrying apparatus 4, so that when the load carrying apparatus carries an object and a force is applied to the support board 40, the load carrying apparatus 4 will produce different levels of deformation at different areas due to the density and position of the first connecting portions 42 and the second connecting portions 43. In FIG. 7A, the load carrying apparatus 4 is divided by a horizontal line into an upper area and a lower area, and the quantity of the first connecting portions 42 and the second connecting portions 43 in the upper area of the load carrying apparatus 4 is smaller than that in the lower area, and the connecting portions of the upper area is more scattered than those of the lower area, so that after a force is applied to the support board 40, the upper area of the load carrying apparatus 4 has a larger deformation, so as to form the accommodating space 5 with the lower area for storing objects. In order to achieve the effect of storing objects more securely, the load carrying apparatus 4 further includes a support frame 44 coupled to an outer side of the (n+1)^{th} elastic ring 41, so that the load carrying apparatus 4 can be placed on a plane as shown in FIG. 7B, wherein the present invention is used as a chair. When a user 6 sits on the load carrying apparatus 4, the elastic rings 41 are deformed by the body weight of the user 6, and the first connecting portions 42 and the second connecting portions 43 adjust the overall deformation of the load carrying apparatus 4 to form the accommodating space 5 provided for the user 6 to sit thereon. After the user 6 leaves the load carrying apparatus 4, the elastic restoring force of the elastic rings 41 automatically return the load carrying apparatus 4 to its original condition, so as to provide a convenient storage and prevent wasting spaces.

In addition, the load carrying apparatus 1, 4 of the present invention may be made of plastic, plastic steel, wood or acrylic according to the scope of application, and the size of the load carrying apparatus 1, 4 and the arrangement of the first connecting portions 12, 42 and the second connecting portions 12, 42 on the load carrying apparatus 1, 4 can be adjusted to expand the scope of application of the load carrying apparatus 1, 4. Besides the application for storing objects, the invention can be used as a chair for users to sit thereon. The present invention can also be used as a lampshade of a decorative lamp or an indoor partition or screen, and the gaps between the deformed elastic rings 11, 41 produce a unique lighting pattern.

What is claimed is:

1. A load carrying apparatus, comprising:
a support board;
a plurality of elastic rings, disposed on an outer side of the support board, and the total number of the elastic rings being n+1, and n being an integer, and the elastic rings being defined as the first to (n+1)^{th} elastic rings respectively;
at least two first connecting portions, disposed between the support board and the first elastic ring, and between the n^{th} elastic ring and the (n+1)^{th} elastic ring, and n being an even number; and
at least one second connecting portion, disposed between the n^{th} elastic ring and the (n+1)^{th} elastic ring, and n being an odd number, wherein an accommodating space is formed after the elastic rings are deformed by an external force, and the support board acts as a load carrying point.

2. The load carrying apparatus of claim 1, wherein the (n+1)^{th} elastic ring has a top area and bottom area greater than those of each of the remaining elastic rings.

3. The load carrying apparatus of claim 2, wherein the (n+1)^{th} elastic ring has at least one assembling portion.

4. The load carrying apparatus of claim 3, wherein the support board and the elastic rings are in a shape selected from the group of a circular shape, a rectangular shape and a polygonal shape.

5. The load carrying apparatus of claim 4, wherein the first connecting portions and the second connecting portions come with a plural quantity, and two first connecting portions are disposed between the support board and the first elastic ring and between the n^{th} elastic ring and the (n+1)^{th} elastic ring, and the two first connecting portions disposed at the positions of the same ring are opposite to each other; and two second connecting portions are disposed between the n^{th} elastic ring and the (n+1)^{th} elastic ring, and the two second connecting portions disposed at the positions of the same ring are opposite to each other, so that the first connecting portions and the second connecting portions are arranged as shown in FIG. 1.

6. The load carrying apparatus of claim 4, wherein the first connecting portions and the second connecting portions come with a plural quantity, and at least three first connecting portions are disposed between the support board and the first elastic ring and between the n^{th} elastic ring and the (n+1)^{th} elastic ring; and at least three second connecting portions are disposed between the n^{th} elastic ring and the (n+1)^{th} elastic ring, so that the first connecting portions and the second connecting portions are arranged as shown in FIG. 3.

7. The load carrying apparatus of claim 4, wherein the first connecting portions and the second connecting portions come with a plural quantity, and four first connecting portions are disposed between the support board and the first elastic ring and between the n^{th} elastic ring and the (n+1)^{th} elastic rings; and two second connecting portions are disposed between the n^{th} elastic ring and the (n+1)^{th} elastic ring, and the two second connecting portions disposed at the positions of the same ring are opposite to each other, so that the first connecting portions and the second connecting portions are arranged as shown in FIG. 4.

8. The load carrying apparatus of claim 5, wherein the first connecting portions disposed at the positions of different rings and the second connecting portions disposed at the positions of different rings are aligned precisely with each other.

9. The load carrying apparatus of claim 6, wherein the first connecting portions disposed at the positions of different rings and the second connecting portions disposed at the positions of different rings are aligned precisely with each other.

10. The load carrying apparatus of claim 7, wherein the first connecting portions disposed at the positions of different rings and the second connecting portions disposed at the positions of different rings are aligned precisely with each other.

11. The load carrying apparatus of claim 4, wherein the first connecting portions and the second connecting portions come with a plural quantity; four first connecting portions are disposed at the (n<15)^{th} elastic ring, between the support board and the first elastic ring, and between the n^{th} elastic ring and the (n+1)^{th} elastic ring; six first connecting portions are disposed at the (n>15)^{th} elastic ring and between the n^{th} elastic ring and the (n+1)^{th} elastic ring; two second connecting portions are disposed at the (n<15)^{th} elastic ring, and between the n^{th} elastic ring and the (n+1)^{th} elastic ring; and four second connecting portions are disposed at the (n>15)^{th} elastic ring, and between the n^{th} elastic ring and the (n+1)^{th} elastic ring, so that the first connecting portions and the second connecting portions are arranged as shown in FIG. 6.
